(19) United States
(12) Patent Application Publication
(10) Pub. No.: US 2014/0063562 A1
(43) Pub. Date: Mar. 6, 2014

(54) ELECTRONIC APPARATUS, MESSAGE SERVER AND METHOD OF CONTROLLING SCANNING

(71) Applicant: SAMSUNG ELECTRONICS CO., LTD, Suwon-si (KR)

(72) Inventors: Ki-moon LEE, Suwon-si (KR); Hyung-chan KIM, Yongin-si (KR); Yu-rim HAN, Suwon-si (KR)

(73) Assignee: Samsung Electronics Co., Ltd, Suwon-si (KR)

(21) Appl. No.: 13/873,573

(22) Filed: Apr. 30, 2013

(30) Foreign Application Priority Data
Aug. 28, 2012 (KR) 10-2012-94345

(51) Int. Cl. H04N 1/00

(52) U.S. Cl. CPC H04N 1/00122
USPC 358/439

(57) ABSTRACT

An electronic apparatus includes a messenger to receive information of a preregistered image scanning unit corresponding to a user account, from a message server, a device manager to send a scan command to an image scanning unit for scanning among the plurality of the image scanning units, based on the received image scanning unit information, and to receive a scan image from the image scanning unit which receives the scan command, and a controller to control the messenger to send a chat message comprising the received scan image and message account information to the message server.

### CROSS-REFERENCE TO RELATED APPLICATIONS

This application claims priority under 35 U.S.C. §119 (a) from Korean Patent Application No. 2012-94345 filed on Aug. 28, 2012 in the Korean Intellectual Property Office, the entire disclosure of which is incorporated herein by reference.

### BACKGROUND OF THE INVENTION

1. Field of the Invention

The present general inventive concept relates generally to an electronic apparatus, a message server, and a method of controlling scanning. More particularly, the present general inventive concept relates to an electronic apparatus of automatically sending a scan image from an image scanning unit to an external apparatus using a message server, the message server, and a method of controlling scanning.

2. Description of the Related Art

In general, an image scanning unit reads and converts an image such as photo, picture, and illustration to a computer file to digitize the image. Examples of the image scanning unit include a scanner, a copier, a fax machine, and a Multi Function Peripheral (MFP) which fulfills functions of the scanner, the copier, and the fax machine in a single device.

According to current scan service techniques, a user stores a scanned file to a storage of a terminal and then shares the scan image using a separate application. Such a scan service requires a separate procedure beforehand to share the scan image with another user. That is, according to the separate procedure, the user needs to send the file on a webpage or to send the scan image using a separate cloud synchronization program or an attachment of an e-mail.

### SUMMARY OF THE INVENTION

The present general inventive concept provides an electronic apparatus to provide a function of sharing a scan image on a messenger program without a separate procedure, a message server, and a method of controlling the scanning.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic apparatus connectable with a plurality of image scanning units and a message server, the electronic apparatus including a messenger to receive information of a preregistered image scanning unit corresponding to a user account, from the message server, a device manager to send a scan command to an image scanning unit to scan among the plurality of the image scanning units, based on the received image scanning unit information, and to receive a scan image from the image scanning unit which receives the scan command, and a controller to control the messenger to send a chat message having the received scan image and message account information to the message server.

The electronic apparatus may further include a user interface to display a list of at least one image scanning unit capable of scanning, based on the received image scanning unit information, and to select the image scanning unit for the scanning on the displayed list.

The user interface may display the list of the at least one image scanning unit on a message chat window.

When the selected image scanning unit is a flatbed type image scanning unit, the user interface may receive a confirmation of an additional scanning job, on the message chat window.

The device manager may search for an available image scanning unit in vicinity of the electronic apparatus, and the messenger may register information of the searched image scanning unit and user account information in the message server.

The information of the image scanning unit may be at least one of device information, function information, and status information of the image scanning unit.

The messenger may send user account information to the message server and receives preregistered image scanning unit information corresponding to the user account information, from the message server.

The messenger may send the chat message to the message server using an extensible messaging and presence protocol (XMPP).

The electronic apparatus may further include a user interface for inputting a scan option on a chat message window. The device manager may send a scan command and the scan option to the image scanning unit for the scanning.

The foregoing and/or other features and utilities of the present general inventive concept may be achieved by providing a message server to send and receive messages to and from an electronic apparatus, the message server including an account manager to send information of a preregistered image scanning unit corresponding to a user account of the electronic apparatus, to the electronic apparatus, a message receiver to receive a chat message having a scan image and message account information from the electronic apparatus, and a message transmitter to send the scan image to an external electronic apparatus based on the message account information.

The message server may further include an image processor to generate a thumbnail image corresponding to the scan image. The message transmitter may send the generated thumbnail message to the other electronic apparatus.

The thumbnail image sent may be displayed on a chat message window of the other electronic apparatus.

When receiving a reception permission command from the other electronic apparatus, the message transmitter may send the scan image to the other electronic apparatus.

The foregoing and/or other features and utilities of the present general inventive concept may be achieved by providing a method of controlling scanning in an electronic apparatus connectable with a plurality of image scanning units and a message server, the method including receiving information of a preregistered image scanning unit corresponding to a user account, from the message server, sending a scan command to an image scanning unit for scanning among the plurality of the image scanning units, based on the received image scanning unit information, receiving a scan image from the image scanning unit which receives the scan command, and sending a chat message comprising the received scan image and message account information to the message server.

The method may further include displaying a list of at least one image scanning unit capable of scanning, based on the received image scanning unit information, and selecting the image scanning unit for the scanning on the displayed list.

The method may further include when the selected image scanning unit is a flatbed type, receiving a confirmation of an additional scanning job, on the message chat window.

The method may further include searching for an available image scanning unit in vicinity of the electronic apparatus, and registering information of the searched image scanning unit and user account information in the message server.

The method may further include inputting a scan option on a chat message window. The sending of the scan command may send a scan command and the scan option to the image scanning unit for the scanning.

The foregoing and/or other features and utilities of the present general inventive concept may also be achieved by providing a method of controlling scanning in a message server capable of sending and receiving messages to and from an electronic apparatus, the method including sending information of a preregistered image scanning unit corresponding to a user account of the electronic apparatus, to the electronic apparatus, receiving a chat message comprising a scan image and message account information from the electronic apparatus, and sending the scan image to other electronic apparatus based on the message account information.

The method may further include generating a thumbnail image corresponding to the scan image; and sending the generated thumbnail message to the other electronic apparatus.

When receiving a reception permission command from the other electronic apparatus, the sending of the scan image may send the scan image to the other electronic apparatus.

The foregoing and/or other features and utilities of the present general inventive concept may also be achieved by providing A non-transitory computer readable medium to contain computer readable codes as a program to execute the method of claim 19.

In the electronic apparatus, a user interface may generate a user interface window to correspond to a chat message with a second electronic apparatus, and the user interface window may include at least one of a scan icon to correspond to at least one of the one or more image scan units, a chat message window to show one or more chat messages with a user of a second electronic apparatus, and a preview window to correspond to a thumbnail image of the scan image, in the user interface window.

The user interface window may be a chat message window.

The user interface window may include a download button such that the user of the second electronic apparatus can download the scan date of the thumbnail image according to a selection of the download button.

The foregoing and/or other features and utilities of the present general inventive concept may also be achieved by providing an electronic apparatus connectable with one or more image scanning units and a message server, including a device manager to receive a scan image form the image scanning unit in response to the scan command, a messenger to send a chat message including the received scan image and message account information to an external message server, and a user interface to generate a user interface window as a chat message window to show one or more chat messages with a user of a second electronic apparatus, and a preview window to correspond to a thumbnail image of the scan image.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIGS. 1 and 2 are block diagrams illustrating a scan system according to an embodiment of the present general inventive concept;

FIG. 3 is a detailed block diagram illustrating an electronic apparatus according to an embodiment of the present general inventive concept;

FIG. 4 is a detailed block diagram illustrating an electronic apparatus according to an embodiment of the present general inventive concept;

FIG. 5 is a detailed block diagram illustrating a message server according to an embodiment of the present general inventive concept;

FIG. 6 is a detailed block diagram illustrating a message server according to an embodiment of the present general inventive concept;

FIGS. 7, 8 and 9 are sequence diagrams of operations of an image scanning unit, the electronic apparatus, and the message server according to an embodiment of the present general inventive concept;

FIGS. 10 and 11 are diagrams illustrating user interface windows displayed on the electronic apparatus according to an embodiment of the present general inventive concept;

FIG. 12 is a flowchart illustrating a method of controlling scanning in an electronic apparatus according to an embodiment of the present general inventive concept; and

FIG. 13 is a flowchart illustrating a scanning controlling method in a message server according to an embodiment of the present general inventive concept.

### DETAILED DESCRIPTION OF THE PREFERRED EMBODIMENTS

Reference will now be made in detail to the embodiment of the present general inventive concept, examples of which are illustrated in the accompanying drawings, wherein like reference numerals refer to the like elements throughout. The embodiment is described below in order to explain the present general inventive concept by referring to the drawings.

Herein, an electronic apparatus can be implemented using a computer, a laptop computer, a tablet Personal Computer (PC), a Portable Multimedia Player (PMP), a Personal Digital Assistant (PDA), a smart phone, or a mobile phone.

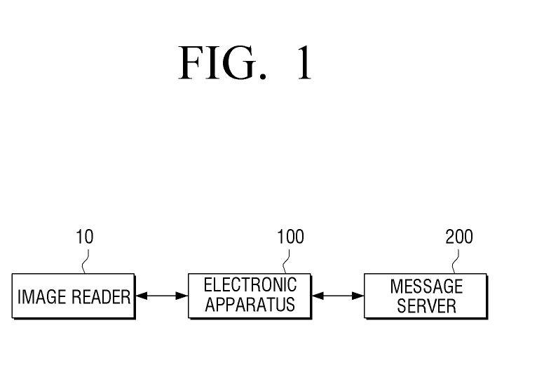

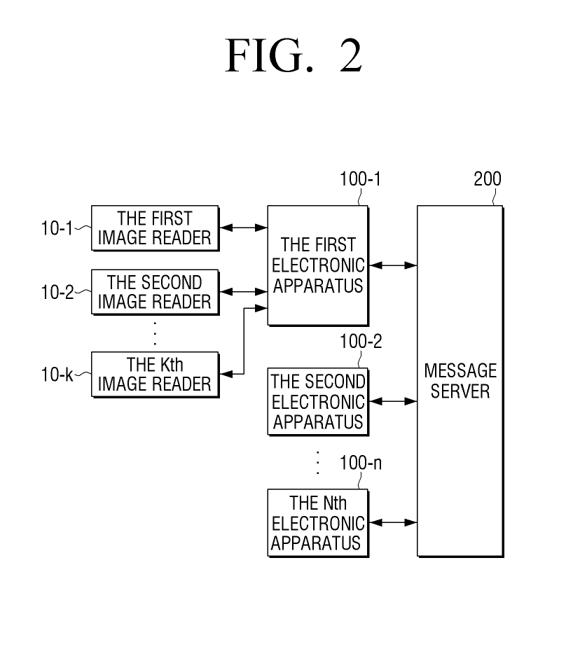

FIGS. 1 and 2 are block diagrams illustrating a scan system according to an embodiment of the present general inventive concept.

Referring to FIG. 1, the scan system includes an image scanning unit (image reader) 10, an electronic apparatus 100, and a message server 200.

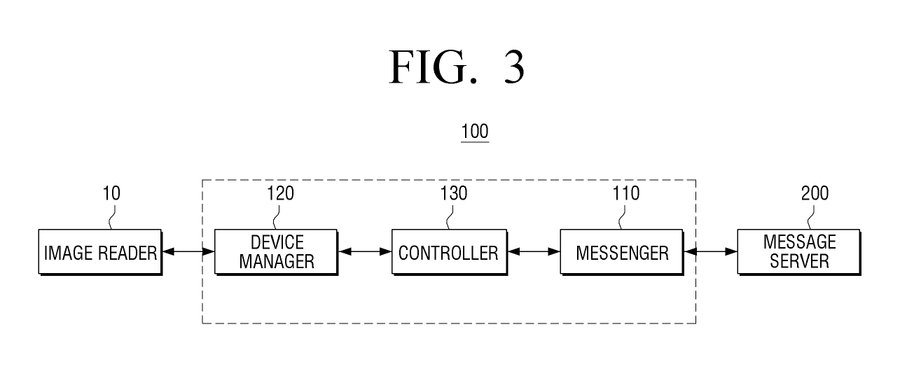

The electronic apparatus 100 can send and receive a message, for example, one or more chat messages, to and from the message server 200. The electronic apparatus 100 can send a scan command to the image scanning unit 10 and receive a scan image. Detailed structure and operations of the electronic apparatus 100 shall be explained by referring to FIG. 3.

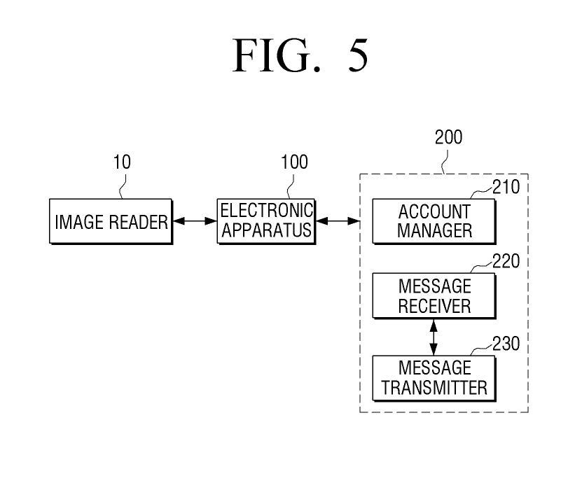

The message server 200 can send and receive the chat messages to and from the electronic apparatus 100. In detail, the message server 200 can receive the chat message from the electronic apparatus 100 and send the scan image of the chat message to an external apparatus. Detailed structure and operations of the message server 200 shall be explained by referring to FIG. 5.

The image scanning unit 10 is connected to the electronic apparatus 100, receives the scan command from the electronic apparatus 100, and performs a scanning operation. The image scanning unit 10 can send device information to the electronic apparatus 100. Herein, the image scanning unit 10 can function as not only a scanner which merely performs the scanning operation to scan a document to generate a scan image, but also an MFP which conducts a copying operation and a printing operation.

Although FIG. 1 illustrates he message server 200 to be connected to the single electronic apparatus 100, it is possible that the message server 200 can be connected with a plurality of electronic apparatuses 100-1 through 100-n as illustrated in FIG. 2. A plurality of users of the respective electronic apparatuses 100-1 through 100-n may be connected to each other through the message server 200.

While the message server 200 is connected directly to the electronic apparatus 100, a router and other message server may be disposed between the message server 200 and the electronic apparatus 100.

While the electronic apparatus 100 is connected to the single image scanning unit 10 in FIG. 1, the electronic apparatus 100 can be connected to a plurality of image scanning units 10-1 through 10-n as shown in FIG. 2. While the electronic apparatus 100 is connected directly to the image scanning unit 10, a router and other message server may be disposed between the electronic apparatus 100 and the image scanning unit 10.

Hereafter, detailed structures of the electronic apparatus 100 and the message server 200 are described.

FIG. 3 is a detailed block diagram illustrating the electronic apparatus 100 of FIGS. 1 and 2 according to an embodiment of the present general inventive concept.

Referring to FIG. 3, the electronic apparatus 100 includes a messenger 110, a device manager 120, and a controller 130.

The messenger 110 sends and receives the chat messages to and from the message server 200. In detail, the messenger 110 can send a chat message including the scan image received from the image scanning unit 10 and message account information, to the message server 200 under control of the controller 130.

Herein, a user account indicates user information usable as personal identification management and security in the message server 200 when the electronic apparatus 100 executes a messenger program to communicate with the message server 200 to send and receive a message to an external electronic apparatus.

The message account information is account information for the message transmission and reception, and can include a recipient user account of the scan image and a sender user account.

The messenger 110 can receive information of the preregistered image scanning unit 10 corresponding to the user account, from the message server 200. In detail, the messenger 110 can send the user account information to the message server 200 and receive the information of the preregistered image scanning unit 10 corresponding to the user account information, from the message server 200.

Herein, the information of the image scanning unit 10 can be at least one of device information, function information, and status information.

The device information of the image scanning unit 10 includes any one of an IP, a HOST NAME, and a MAC Address.

The messenger 110 can send the message to the message server 200 using extensible messaging and presence protocol (XMPP). The messenger program executed in the electronic apparatus 100 may be an instant messenger program using the XMPP and can use an instant message dedicated to the scanning and a commercial messenger program (for example, GOOGLE talk, MSN Messenger, AOL Messenger, and YAHOO Messenger) using the XMPP.

Meanwhile, when the device manager 120 discovers the image scanning unit 10, to register the image scanning unit 10 in the message server 200, the messenger 110 can transmit and register information of the discovered image scanning unit 10 and the user account information to the message server 200.

The device manager 120 is connected to the image scanning unit 10 to transmit and receive data. In detail, the device manager 120 can send the scan command to the image scanning unit 10 which will perform the scanning, among the plurality of the image scanning units, based on the information of the image scanning unit 10 preregistered in the messenger 110, and receive the scan image from the image scanning unit 10 which receives the scan command.

The device manager 120 may send a scan option together with the scan command. For example, the scan option includes any one of scan quality setting, scan speed setting, duplex scan setting, ADF support, and file format setting. The scan option can be set by, but not limited to, a user's selection in the scanning process, or may be pre-stored.

The device manager 120 can search for the available image scanning unit 10 available to the electronic apparatus 100. The image scanning unit 10 discovered by the device manager 120 can be registered in the message server 200 through the messenger 110.

The controller 130 controls the operations of the components of the electronic apparatus 100. For example, the controller 130 can control the messenger 110 to send the chat message including the scan image received from the device manager 120 and the message account information, to the message server 200.

As constructed above, the electronic apparatus 100 can be used in the scan system of FIG. 1.

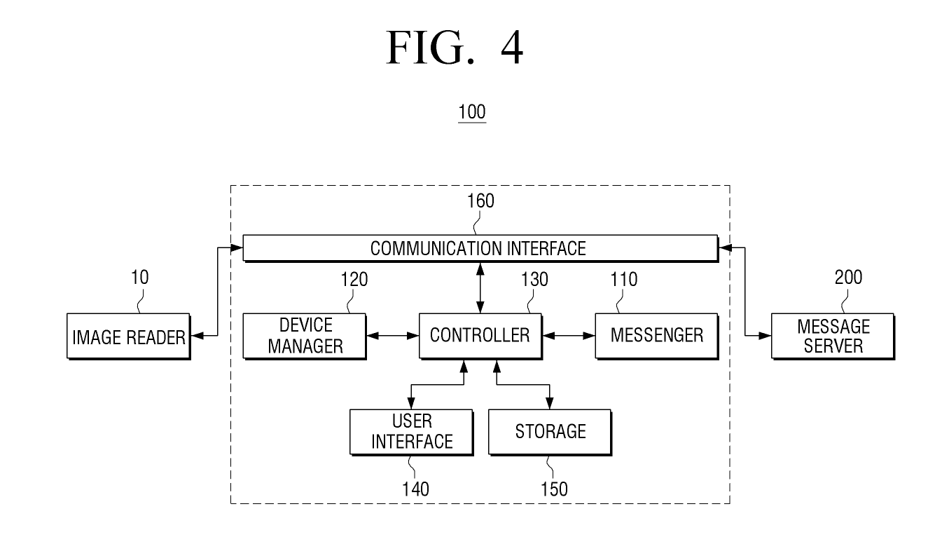

FIG. 4 is a detailed block diagram illustrating the electronic apparatus 100 of FIG. 1, 2, or 3 according to an embodiment of the present general inventive concept.

Referring to FIG. 4, the electronic apparatus 100 can include the messenger 110, the device manager 120, the controller 130, a user interface 140, a storage 150, and a communication interface 160.

Since operations of the messenger 110, the device manager 120, and the controller 130 have been explained in FIG. 3, detailed descriptions thereof will be omitted here.

The user interface 140 can include a display panel to display an image, and at least one button as an input element. The display panel can be implemented using a touch screen or panel useable as an input and output element. The user interface 140 provides one more user interface (UI) screens, and a user can input a user selection command by directly touching the UI screen or manipulating the button of the user interface 140. The selection command can set one or more functions of the electronic apparatus 100, or change a mode or abort or resume the operation thereof.

The user interface 140 can receive an execution command of the messenger program. When the messenger program is executed according to the execution command, the user interface 140 can display a user interface window to input the user account information.

The user interface 140 can display a list of at least one image scanning unit 10 capable of scanning, based on the information of the image scanning unit 10 received at the messenger 110, and select the image scanning unit 10 from the displayed list.

The user interface 140 can display the list of the at least one image scanning unit on a message chat window.

When the image scanning unit 10 selected for the scanning is a flatbed type image scanning unit, the user interface 140 can display an additional scanning job in the message chat window and receive the selection.

The flatbed image scanning unit can scan only one document through one scanning job. To scan multiple documents, the additional scanning job needs to be confirmed before the additional scanning.

The user interface 140 can display a scan option setting window so as to receive a user's selection and set the scan option. The document can be scanned and a scan file is generated, according to the set scan option.

The storage 150 stores various data processed by components or units of the electronic apparatus 100, and data received from an external source. In detail, files stored to the storage 150 can include scan image files with extensions BMP and JPG, and printing data files with extensions PDF and XPS. The storage 150 stores the chat message.

Under the control of the controller 130, the storage 150 can store input/output signals, information, or data according to the operations of the messenger 110, the device manager 120, the user interface 140, and the communication interface 160.

The storage 150 can store a control program to control the electronic apparatus 100 or the controller 130, and applications. Hereafter, the term “storage” can include the storage 150, a ROM, a RAM, or a memory card (e.g., SD card or memory stick) attachable/detachable to and from the electronic apparatus 100. The storage 150 can include a nonvolatile memory, a volatile memory, a Hard Disc Drive (HDD), or a Solid State Drive (SSD).

The communication interface 160 communicates with the message server 200 and the image scanning unit 10 under the control of the messenger 110 and the device manager 120. While the messenger 110 and the device manager 120 are connected directly with the message server 200 and the image scanning unit in FIG. 3, they can be connected with each other via the communication interface 160 according to an embodiment of the present general inventive concept. It is possible that the communication interface 160 is formed to connect the electronic apparatus 100 to an external device (apparatus), and may access the message server 200 and the image scanning unit 10 not only over a local area network (LNA) and an Internet but also using a wireless communication scheme (e.g., GSM, UMTS, and LTE).

FIG. 5 is a detailed block diagram illustrating the message server 200 of FIG. 1, 2, 3, or 4 according to an embodiment of the present general inventive concept.

Referring to FIG. 5, the message server 200 includes an account manager 210, a message receiver 220, and a message transmitter 230.

The account manager 210 manages the user account of the electronic apparatus 100. When the messenger program of the electronic apparatus 100 is executed, the account manager 210 receives the user account from the electronic apparatus 100 and authenticates the user.

The account manager 210 registers the image scanning unit 10 to associate with the user account of the electronic apparatus 100. When the electronic apparatus 100 requests to register the image scanning unit 10, the account manager 210 links and stores the requested image scanning unit 10 to the user account of the electronic apparatus 100. Next, according to the messenger program execution, the account manager 210 can send the device information of the image scanning unit 10 preregistered and stored, to the electronic apparatus 100.

The message receiver 220 receives the chat message from the electronic apparatus 100. Herein, the chat message can include at least one of text data, image data (scan image), voice data, account information, and location information.

In this embodiment of the present general inventive concept, the message receiver 220 can receive the chat message including the scan image from the electronic apparatus 100 and the message account information. Herein, the message account information is account information for the message transmission and reception and includes a recipient account of the scan image and a sender user account.

The message transmitter 230 sends the chat message received from the electronic apparatus (one user) 100 to an external electronic apparatus (another user). That is, the message transmitter 230 sends the scan image to an external electronic apparatus based on the message account information received from the electronic apparatus 100. Herein, when receiving a reception permission command from an external electronic apparatus, the message transmitter 230 can send the scan image to the external electronic apparatus.

When an image processor 250 generates a thumbnail image corresponding to the scan image, the message transmitter 230 can send the thumbnail image to the external electronic apparatus. It is possible that the image transmitter 230 may transmit the thumbnail image to one or more electronic apparatus according to allowability included in message account information of the corresponding electronic apparatus or setting options of the message server 200.

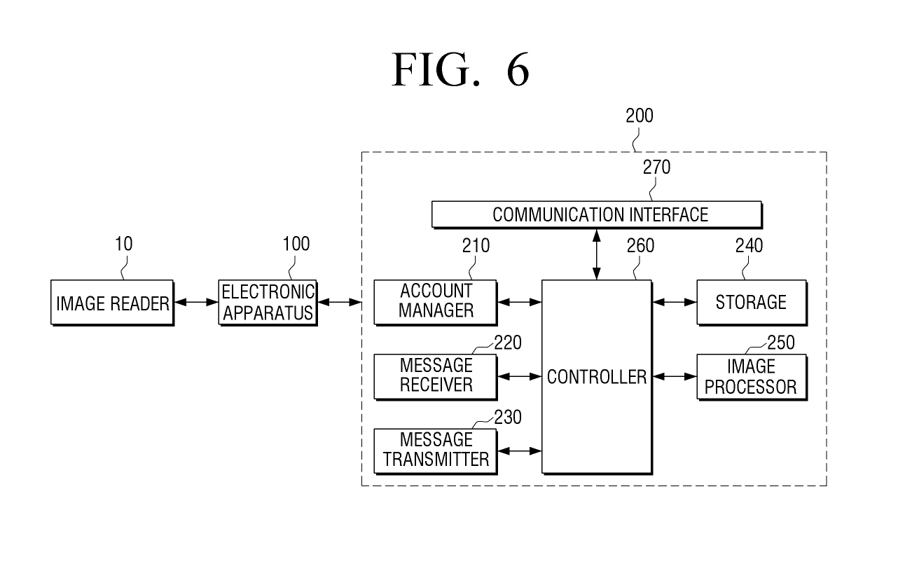

FIG. 6 is a detailed block diagram illustrating the message server 200 of FIG. 1, 2, 3, 4, or 5 according to an embodiment of the present general inventive concept.

Referring to FIG. 6, the message server 200 can include the account manager 210, the message receiver 220, the message transmitter 230, a storage 240, the image processor 250, a controller 260, and a communication interface 270.

Since operations of the account manager 210, the message receiver 220, and the message transmitter 230 have been explained in FIG. 5, detail description thereof will be omitted here.

The storage 240 stores various data processed by the components of the message server 200, and data received from an external source. In detail, files stored to the storage 240 can include scan image files with the extensions, for example, BMP and JPG, and printing data files with the extensions, for example, PDF and XPS. The storage 240 stores the chat message, the user account, and the image scanning unit information.

The storage 240 can store a control program to control the message server 200, and applications. Hereafter, the term “storage” can include the storage 240, a ROM, a RAM, or an attachable/detachable memory card (e.g., SD card or memory stick) of the message server 200. The storage 240 can include a nonvolatile memory, a volatile memory, a HDD, or an SSD.

The image processor 240 generates the thumbnail image corresponding to the received scan image (image data). The thumbnail image indicates a scaled-down scan image for easy preview before an actual scan image corresponding to the received scan image (image data) is downloaded or further processed.

Hence, the image processor 250 can enhance legibility of the scan image of the document, or perform additional image processing such as layout correction.

The processed thumbnail image and the scan image can be stored to the storage 240.

The controller 260 controls the operations of the components of the message server 200.

The communication interface 270 communicates with the electronic apparatus 100 under the control of the account manager 210, the message receiver 220, and the message transmitter 230. While the account manager 210, the message receiver 220, and the message transmitter 230 are connected directly with the electronic apparatus 100 in FIG. 5, they can be connected with each other via the communication interface 270 according to various embodiments of the present general inventive concept. Specifically, the communication interface 270 is formed to connect the message server 200 to an external device, and may access the electronic apparatus 100 not only over the LNA and the Internet but also using the wireless communication scheme (e.g., GSM, UMTS, and LTE).

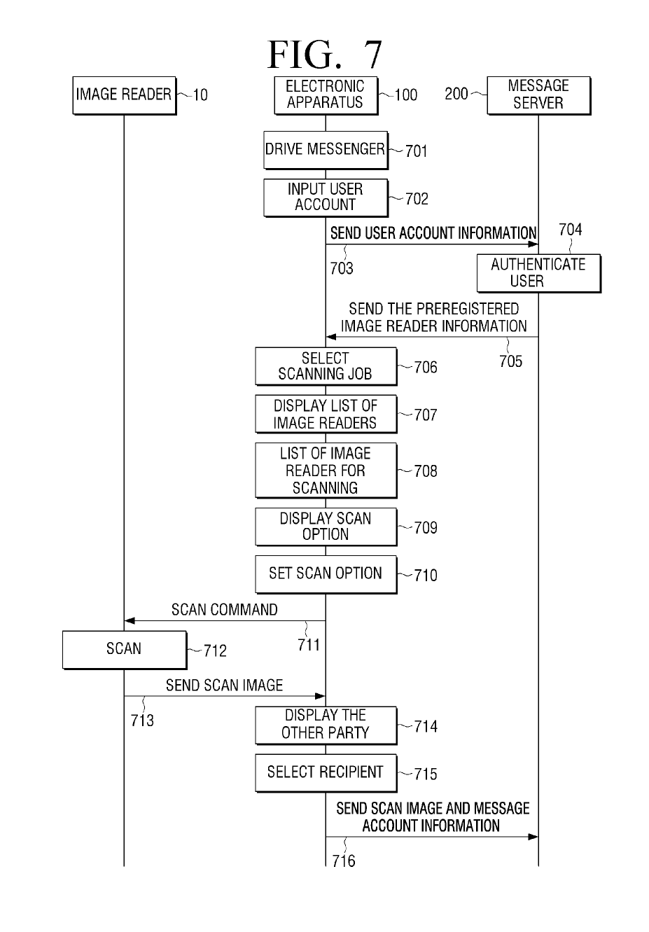

FIGS. 7, 8 and 9 are sequence diagrams illustrating the operations of the image scanning unit 10, the electronic apparatus 100, and the message server 200 of FIGS. 1 through 6 according to an embodiment of the present general inventive concept.

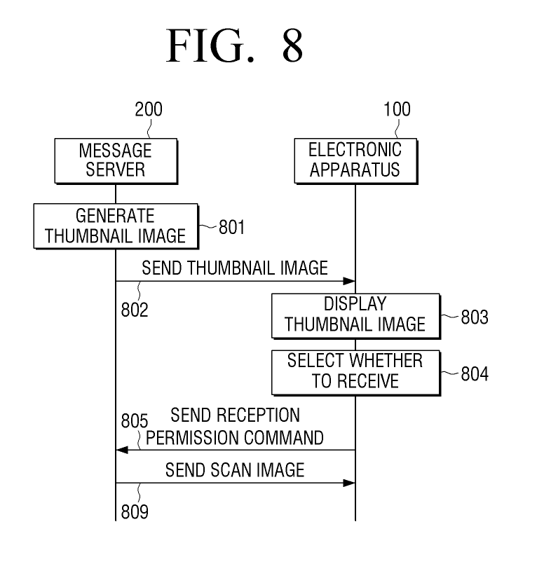

FIG. 7 illustrates operations of sending the scan image to the message server 200, and FIG. 8 illustrates the operations of sharing the scan image with an external electronic apparatus.

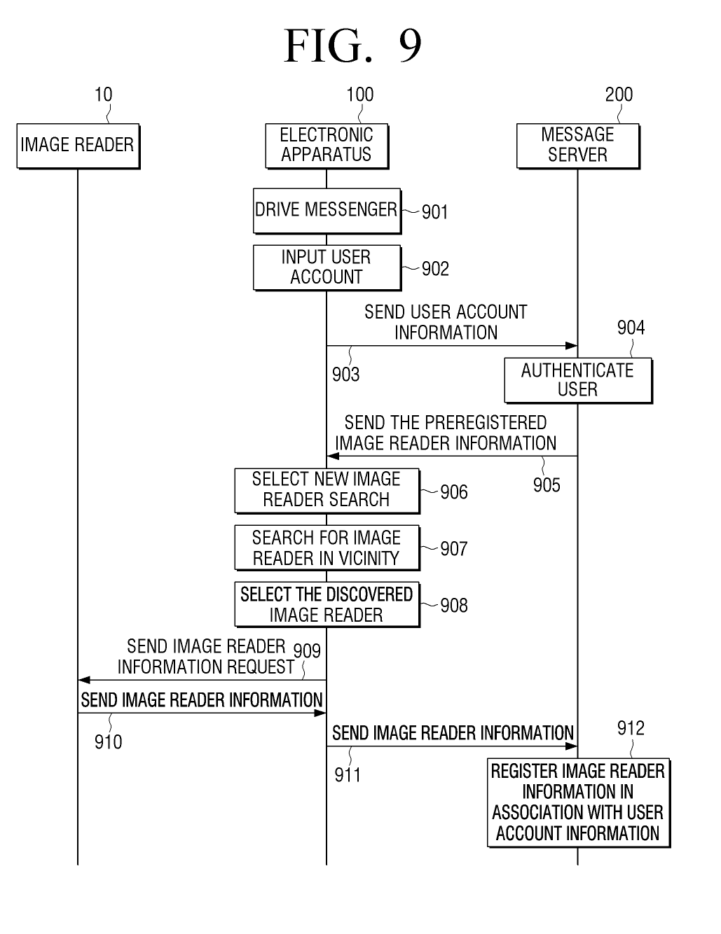

FIG. 9 illustrates the operations of registering the image scanning unit 10 in the message serve 200.

Referring to FIG. 7, when the electronic apparatus 100 executes the messenger program in operation 701, the user account is input through the user interface 140 in operation 702.

The electronic apparatus 100 transmits the user account information to the message server 200 in operation 703, and the message server 200 authenticates the user in operation 704. This process can be referred to as a log-in process.

When the user authentication is successful, the message server 200 sends the information of the preregistered image scanning unit 10 associated with the user account, to the electronic apparatus 100 in operation 705.

When the user selects a scan job in operation 706, the electronic apparatus 100 displays the list of the one or more image scanning units 10 based on the received information of the one or more image scanning units 10 in operation 707. The user selects at least one of the one or more image scanning units 10 to perform the scanning in operation 708.

Herein, a scan option of the scan job is displayed in operation 709 so that the user can set the scan option in operation 710.

When the user selection is completed, the electronic apparatus 100 sends the scan command to the image scanning unit 10 in operation 711. Hence, the image scanning unit 10 performs the scanning according to the scan option of the scan job in operation 712. It is possible that when the image scanning unit 10 is the flatbed type image scanning unit, an additional scanning job may need to be confirmed by the electronic apparatus 100.

When finishing the scanning, the image scanning unit 10 sends the scan image to the electronic apparatus 100 in operation 713.

The electronic apparatus 100 displays the account of the other party (an external electronic apparatus corresponding to another user) to participate in a chat room of the messenger program in operation 714, and selects the other party account to send the scan image in operation 715.

The electronic apparatus 100 sends the chat message including the scan image and the message account information to the message server 200 in operation 716. Although FIG. 7 illustrates that the electronic apparatus 100 transmits the message account information together with the scan image included in the chat message in operation 716, it is possible that the message account information can be transmitted from the electronic apparatus 100 to the message server 200 during communication between the electronic apparatus 100 and the message server 200 in an operation other than the operation 716.

FIG. 8 illustrates a method of sharing the scan image with the electronic apparatus 100 (for example, the other party or 100-n of FIG. 2) through the message server 200.

Referring to FIG. 8, the message server 200 receives the chat message including the scan image and the message account information and generates the thumbnail image in operation 801. The thumbnail image is provided as a preview to be provided to another user of the electronic apparatus 100. The thumbnail image is transmitted based on the recipient account of the other party of the message account information in operation 802.

The electronic apparatus 100 receiving the thumbnail image displays the thumbnail image in operation 803 and the user selects whether to receive the image in operation 804.

When the reception permission is selected, the electronic apparatus 100 sends the reception permission command to the message server 200 in operation 805 and the message server 200 sends the scan image to the electronic apparatus 100 which permits the reception in step 809. Thus, the scan image can be shared.

As above, the scan image can be shared on the messenger program without a separate procedure as illustrated in FIGS. 7 and 8.

FIG. 9 illustrates a method of registering the image scanning unit 10 in the message server 200 according to an embodiment of the present general inventive concept.

Referring to FIG. 9, the electronic apparatus 100 executes the messenger program in operation 901, receives the user account in operation 902, and sends the user account to the message server 200 in operation 903.

When the message server 200 authenticates the user in operation 904, it sends the information of the preregistered image scanning unit 10 associated with the user account to the electronic apparatus 100 in operation 905.

When the user selects to search for a new image scanning unit 10 in the electronic apparatus 100 in operation 906, the electronic apparatus 100 searches for any connectable image scanning unit 100 in vicinity in operation 907.

Next, the electronic apparatus 100 displays the searched image scanning unit 10 and receives the user's selection in operation 908.

The electronic apparatus 100 sends an information request of the selected image scanning unit 10 in operation 909 and receives information from the image scanning unit 10 in operation 910.

The electronic apparatus 100 sends the information of the image scanning unit 10 to register at the message server 200 in operation 911. The message server 200 registers the information of the image scanning unit 10 in association with the user account information in operation 912.

Hence, the user can register the new image scanning unit 10, and use the preregistered image scanning unit 10 even when accessing the messenger program through other electronic apparatus 100 in association with the user account.

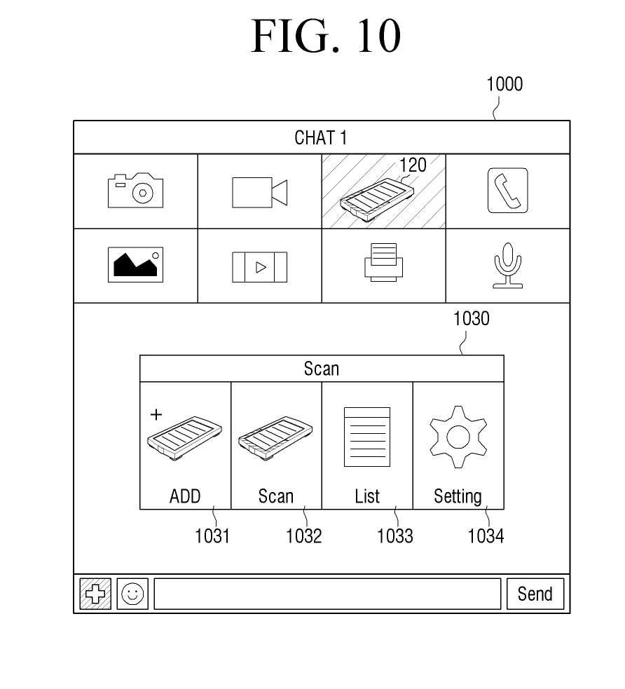

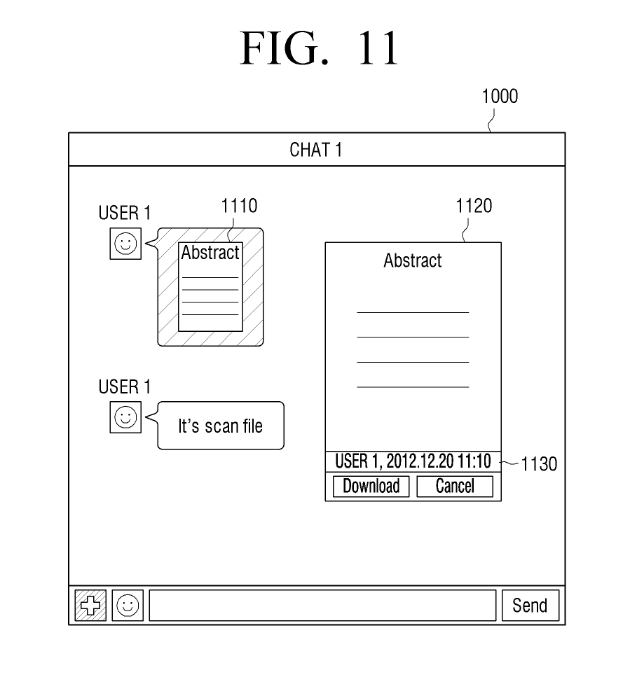

FIGS. 10 and 11 illustrate user interface windows displayed on the electronic apparatus 100 according to an embodiment of the present general inventive concept.

FIG. 10 illustrates a messenger program interface 1000 as the user interface window. When a menu for the messenger program is selected, menu icons can be displayed in an upper portion of the messenger program interface 1000.

Herein, when a scan icon 120 is selected, a scan menu 1030 can be popped up and displayed in a lower portion of the messenger program interface 1000.

The scan menu 1030 can display a new image scanning unit add menu 1031, a scan selection menu 1032, a list menu of image scanning units preregistered 1033, and an image scanning unit setting menu 1034.

FIG. 11 illustrates the messenger program interface 1000 as the user interface window to show a scan image to be shared during a conversation (communication) with the other party in the messenger program.

When the other party of USER 1 shares the scan image, the scan image can be delivered by the chat message. In this case, the scan image can be displayed as a chat message 1110 of a thumbnail image type.

As the user selects (or touches) the thumbnail image, a preview window 1120 can be displayed and information 1130 of the thumbnail image can be displayed. Herein, when a Download button is selected, the scan image can be sent and stored to the electronic apparatus 100.

The download button can be selected by the other party of USER 1. However, the present general inventive concept is not limited thereto. It is possible that the download button can be selected by a user of the electronic apparatus 100 according to a user preference or setting.

The user interface window may include a chat message window and may be displayed on a corresponding display panel of the electronic apparatus and the third party electronic apparatus.

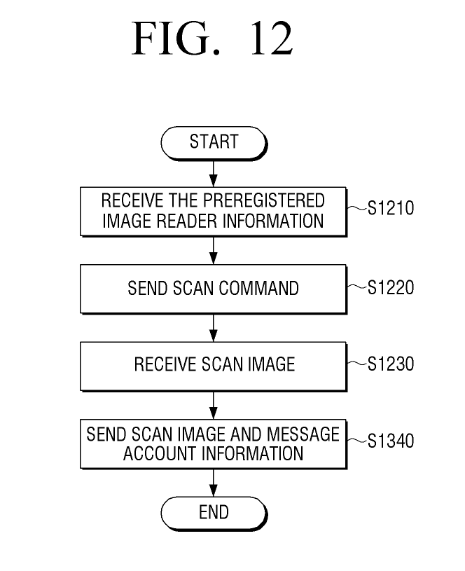

FIG. 12 is a flowchart illustrating a method of controlling the scanning in the electronic apparatus 100 according to an embodiment of the present general inventive concept.

Referring to FIG. 12, the electronic apparatus 100 receives the information of the preregistered image scanning unit corresponding to the user account, from the message server 200 at operation S1210.

Based on the received image scanning unit information, the electronic apparatus 100 can display the list of at least one image scanning unit capable of scanning. The image scanning unit for the scanning can be selected in the displayed list.

The electronic apparatus 100 sends the scan command to the image scanning unit for the scanning, based on the received image scanning unit information at operation S1220.

At this time, when the selected image scanning unit is the flatbed type, the electronic apparatus 100 can confirm whether to conduct the additional scanning job in the message chat window, and send the confirmation to the image scanning unit.

The san option can be input in the chat message window, and accordingly the scan command and the scan option can be sent to the image scanning unit at the same time.

The electronic apparatus 100 receives the scan image from the image scanning unit (S1230) and sends the chat message including the received scan image and the message account information to the message server at operation S1240.

Next, the other electronic apparatus can receive the shared scan image via the message server 200.

The controlling method of the electronic apparatus of FIG. 12 can be fulfilled by the electronic apparatus 100 of FIG. 3, or by other electronic apparatuses.

As illustrated above, the scanning controlling method of the electronic apparatus can share the scan image in the messenger without a separate additional procedure.

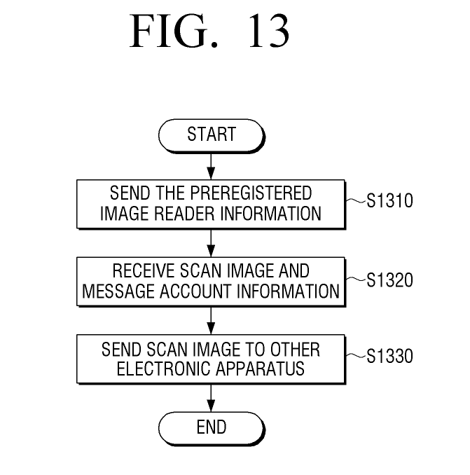

FIG. 13 is a flowchart illustrating a scanning controlling method in the message server according to an embodiment of the present general inventive concept.

Referring to FIG. 13, the message server sends the information of the preregistered image scanning unit corresponding to the user account of the electronic apparatus, to the electronic apparatus at operation S1310.

The message server receives the chat message including the scan image and the message account information from the electronic apparatus at operation S1320.

Next, the message server can generate the thumbnail image corresponding to the scan image and send the generated thumbnail image to other electronic apparatus based on the message account information.

The message server sends the scan image to other electronic apparatus based on the message account information at operation S1330. More specifically, upon receiving the reception permission command from the other electronic apparatus, the message server can send the scan image to the other electronic apparatus.

Meanwhile, the controlling method of the electronic apparatus of FIG. 13 can be fulfilled by the message server 200 of FIG. 5, or by other message servers.

As illustrated above, the message server can share the scan image without a separate additional procedure in the messenger.

The method according to an embodiment of the present general inventive concept can be programmed and stored to various storage media. Accordingly, various electronic apparatuses which run the storage media can fulfill the methods according to various embodiments of the present general inventive concept.

In detail, a computer readable medium can contain the program for sequentially fulfilling the operation to receive the information of the preregistered image scanning unit corresponding to the user account from the message server, the operation to send the scan command to the image scanning unit for the scanning among the plurality of the image scanning units based on the received image scanning unit information, the operation to receive the scan image from the image scanning unit which receives the scan command, and the operation to send the chat message including the received scan image and the message account information to the message server.

The computer readable medium indicates a device-readable medium for storing data semi-permanently, rather than the medium such as register, cache, or memory which stores the data during a short time. Specifically, various applications or programs can be stored to the non-transitory computer readable medium such as CD, DVD, hard disc, BlueRay disc, USB, memory card, and ROM.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus connectable with one or more image scanning units and a message server, comprising:
a messenger to receive information of a preregistered image scanning unit corresponding to a user account, from the message server;
a device manager to send a scan command to at least one of the one or more image scanning units, based on the received image scanning unit information, and to receive a scan image from the image scanning unit which receives the scan command; and
a controller to control the messenger to send a chat message including the received scan image and message account information to the message server.

2. The electronic apparatus of claim 1, further comprising:
a user interface to display a list of the one or more image scanning units capable of scanning, based on the received image scanning unit information, and selecting the image scanning unit for the scanning from the displayed list.

3. The electronic apparatus of claim 2, wherein the user interface displays the list of the one or more image scanning units on a message chat window.

4. The electronic apparatus of claim 2, wherein, when the selected image scanning unit is a flatbed type, the user interface receives a confirmation of an additional scanning job, on the message chat window.

5. The electronic apparatus of claim 1, wherein:
the device manager searches for the one or more image scanning unit available to the electronic apparatus; and
the messenger registers information of the searched image scanning unit and user account information in the message server.

6. The electronic apparatus of claim 1, wherein the information of the image scanning unit is at least one of device information, function information, and status information of the image scanning unit.

7. The electronic apparatus of claim 1, wherein the messenger sends user account information to the message server and receives preregistered image scanning unit information corresponding to the user account information, from the message server.

8. The electronic apparatus of claim 1, wherein the messenger sends the chat message to the message server using an extensible messaging and presence protocol, XMPP.

9. The electronic apparatus of claim 1, further comprising:
a user interface to input a scan option on a chat message window,
wherein the device manager sends a scan command and the scan option to the image scanning unit for the scanning.

10. A message server to send and receive one or more messages to and from an electronic apparatus, comprising:
an account manager to send information of a preregistered image scanning unit corresponding to a user account of the electronic apparatus, to the electronic apparatus;
a message receiver to receive a chat message including a scan image and message account information from the electronic apparatus; and
a message transmitter to send the scan image to a second electronic apparatus based on the message account information.

11. The message server of claim 10, further comprising:
an image processor to generate a thumbnail image corresponding to the scan image,
wherein the message transmitter sends the generated thumbnail message to the second electronic apparatus.

12. The message server of claim 11, wherein the thumbnail image sent is displayed on a chat message window of the second electronic apparatus.

13. The message server of claim 10, wherein, when receiving a reception permission command from the second electronic apparatus, the message transmitter sends the scan image to the second electronic apparatus.

14. A method of controlling scanning in an electronic apparatus connectable with one or more image scanning units and a message server, the method comprising:
receiving information of a preregistered image scanning unit corresponding to a user account, from the message server;
sending a scan command to one of the one or more image scanning units, based on the received image scanning unit information;
receiving a scan image from the image scanning unit which receives the scan command; and
sending a chat message including the received scan image and message account information to the message server.

15. The method of claim 14, further comprising:
displaying a list of the one or more image scanning units capable of scanning, based on the received image scanning unit information; and
selecting the image scanning unit from the displayed list.

16. The method of claim 14, further comprising:
when the selected image scanning unit is a flatbed type image scanning unit, receiving a confirmation of an additional scanning job, on the message chat window.

17. The method of claim 14, further comprising:
searching for the image scanning unit available to the electronic apparatus; and
registering information of the searched image scanning unit and user account information in the message server.

18. The method of claim 14, further comprising:
inputting a scan option on a chat message window,
wherein the sending of the scan command sends a scan command and the scan option to the image scanning unit for the scanning.

19. A method of controlling scanning in a message server capable of sending and receiving messages to and from an electronic apparatus, the method comprising:
sending information of a preregistered image scanning unit corresponding to a user account of the electronic apparatus, to the electronic apparatus;
receiving a chat message including a scan image and message account information from the electronic apparatus; and
sending the scan image to a second electronic apparatus based on the message account information.

20. The method of claim 19, further comprising:
generating a thumbnail image corresponding to the scan image; and
sending the generated thumbnail message to the second electronic apparatus.

21. The method of claim 19, wherein, when receiving a reception permission command from the second electronic apparatus, the sending of the scan image sends the scan image to the second electronic apparatus.

22. The electronic apparatus of claim 1, further comprising:
a user interface to generate a user interface window to correspond to a chat message with a second electronic apparatus,
wherein the controller controls the user interface to display at least one of a scan icon to correspond to at least one of the one or more image scan units, a chat message window to show one or more chat messages with a user of a second electronic apparatus, and a preview window to correspond to a thumbnail image of the scan image, in the user interface window.

23. The electronic apparatus of claim 22, wherein the user interface window is a chat message window.

24. The electronic apparatus of claim 22, wherein the user interface window includes a download button such that the user of the second electronic apparatus can download the scan date of the thumbnail image according to a selection of the download button.

25. An electronic apparatus connectable with one or more image scanning units and a message server, comprising:
a device manager to receive a scan image form the image scanning unit in response to the scan command;
a messenger to send a chat message including the received scan image and message account information to an external message server; and
a user interface to generate a user interface window as a chat message window to show one or more chat messages with a user of a second electronic apparatus, and a preview window to correspond to a thumbnail image of the scan image.
